(19) United States
(12) Patent Application Publication
(10) Pub. No.: US 2017/0101322 A1
(43) Pub. Date: Apr. 13, 2017

(54) METHOD FOR SEPARATING AMMONIA OUT OF AN ALCOHOLIC SOLUTION IN THE PRESENCE OF CARBONIC ACID COMPOUNDS

(71) Applicant: EVONIK RÖHM GMBH, Darmstadt (DE)

(72) Inventors: Alexander MAY, Seeheim-Jugenheim (DE); Willi PLOESSER, Seeheim-Jugenheim (DE); Markus Rolf ROSSMEISSL, Darmstadt (DE); Steffen KRILL, Muehltal (DE); Martin KOESTNER, Darmstadt (DE)

(73) Assignee: Evonik Roehm GmbH, Darmstadt (DE)

(21) Appl. No.: 15/127,937

(22) PCT Filed: Mar. 13, 2015
(86) PCT No.: PCT/EP2015/055252

§ 371 Date: Sep. 21, 2016

(30) Foreign Application Priority Data
Mar. 21, 2014 (DE) 10 2014 205 304.8

(51) Int. Cl. C01C 1/10; B01D 3/42; B01D 5/00

(52) U.S. Cl. CPC C01C 1/10; B01D 5/0063; B01D 3/42; C01P 2006/80

(57) ABSTRACT

The present invention describes a method of removing ammonia from alcoholic solution in the presence of carbonic acid compounds while avoiding fouling by supplying the solution to be separated to the upper part of a distillation column and adjusting the temperature at the introduction point such that the ammonium salts of the carbonic acid compound in question are soluble in the in question at the top of the distillation column under the operating conditions.

The present invention describes a method of removing ammonia from an alcoholic solution in the presence of carbonic acid compounds while avoiding fouling.

The removal of ammonia from reaction mixtures comprising carbonic acid compounds has been extensively described. EP 572778 describes a method of recovering ammonia and organic compounds from offgases laden with organic substances, carbon dioxide and ammonia by scrubbing out carbon dioxide with aqueous alkali metal hydroxide solution in a column, drawing off ammonia overhead and removing the alkali metal carbonate-containing organic compounds from the bottoms. In the case of water-insoluble organic compounds, said compounds and the carbonate lye generated in the column bottom form two layers in the work-up and may be separated from one another relatively easily. In the case of water-soluble organic compounds, for example short-chain alcohols, said compounds require costly and inconvenient purification in an additional distillation step.

EP 88478 describes a complex method consisting of a plurality of rectification columns and scrubbers for separating ammonia, carbon dioxide and water. The method is complex and energy intensive.

EP 2082794 describes a method of separating ammonia and methanol (MeOH) by stripping the respective solution with an inert gas. However, in this method ammonia in the MeOH is only depleted and not removed completely. There is a concomitant loss of large amounts of MeOH to the inert gas stream which in certain circumstances constitute a loss of the product of value and require disposal since condensation of the target compound is uneconomical due to the high inert content.

U.S. Pat. No. 3,013,065 claims a method of reacting urea with ethanol to obtain ethyl carbamate wherein ammonia comprising, inter alia, CO₂ needs to be removed from a reaction solution. The latter is separated from the ammonia by deposition as ammonium carbamate in two condensers operated in parallel. The separation is carried out in one step, no mention being made of a column for improving the separation of ethanol and ammonia. The extent to which corresponding solid deposits would have to be avoided in an optional column arranged downstream of the reactor is not discussed.

Other methods, as referred to in WO 200904744 for example, utilize, for example, alkali metal hydroxides, alkaline earth metal oxides or alkanolamines as carbon dioxide scavengers which in turn need to be recycled in costly and inconvenient regeneration processes.

The Benfield process employs a potassium carbonate CO₂ scavenger which is converted into potassium hydrogencarbonate and is regenerable by elimination of CO₂. Here too, there are the problems of removing the generated aqueous hydrogen-carbonate solution from the target product which in some cases is likewise aqueous and of subsequently regenerating the potassium carbonate.

The literature moreover describes examples of adsorptive removal of CO₂ using basic ion exchangers which generally likewise entail appreciable regeneration costs.

It is an object of the present invention to provide a method of removing ammonia from in particular alcoholic reaction mixtures comprising carbonic acid compounds which is energy saving, uses simple apparatus and avoids the abovementioned problems of the prior art or at least minimizes them. It is a particular object of the present invention to provide a method which in continuous operation ensures a very long run time without outages due to fouling at critical points in the method and which provides both ammonia and the desired organic compound in high purity.

This object is achieved by a method of removing ammonia from an alcoholic solution comprising at least one alcohol and one carbonic acid compound as well as ammonia, characterized in that

a) the solution is introduced to the middle, the top half or the top of a distillation column and

b) the pressure and temperature at the introduction point are adjusted such that the ammonium salts of the carbonic acid compound in question are soluble in the alcohol in question under the operating conditions.

Surprisingly, this procedure avoids any fouling of the column, thereby avoiding frequent cleaning intervals.

Suitable alcoholic solutions to be freed of ammonia include those comprising at least one alcohol and one carbonic acid compound as well as ammonia. Alcohols employable in accordance with the invention include mono- and polyhydric aliphatic, cycloaliphatic and aromatic alcohols comprising 1-20 carbon atoms, preferably aliphatic alcohols comprising 1-10 carbon atoms and more preferably MeOH, ethanol, propanol and butanol and also their respective mixtures.

The term carbonic acid compounds is to be understood as meaning carbonic acid itself, CO₂, salts of carbonic acid such as hydrogencarbonates, carbonates, carbamates and mixtures thereof.

The ammonia obtained is preferably supplied to a process for preparing hydrocyanic acid, more preferably a process for preparing hydrocyanic acid by the Andrussow process.

The solution may further comprise additional constituents, in particular aliphatic amines such as di- and trialkylamine, dialkyl ether, dialkyl ketones or formamide, alkyl formates, alkyl acetates.

Useful distillation columns include prior art columns as described, for example, in Klaus Sattler, “Thermische Trennverfahren” [Thermal separation methods], third edition, Wiley, 2001, p 151. Columns comprising tray internals are preferred.

Fouling by the ammonium salts of the carbonic acid compounds invariably occurs as soon as the temperature falls below the decomposition temperature of said salts, about 50° C. at atmospheric pressure for ammonium carbamate for example, or when at temperatures below the decomposition temperature the operating conditions are such that the concentration of said salts exceeds the solubility thereof in the alcohol to be removed. In accordance with the invention, the feed stream is introduced to the middle, the top half or the top of the column and the temperature and pressure at the introduction point are adjusted such that the ammonium salts of the carbonic acid compound in question are soluble in the alcohol in question at the top of the column under the operating conditions. Introducing the feed stream to at least the middle of the column and ensuring a sufficiently high temperature ensures there is always a high solvent content in the part of the column therebelow to preclude disruptive fouling. At an operating pressure of 1 bar, the temperature at the uppermost tray should not fall below 40° C.

The operating pressure is 0.05-5, preferably 0.2-4 and more preferably 1-3.5 bar.

The ammonia concentration at the uppermost tray of the distillation column must not exceed 10 wt %. This is ensured by providing sufficient heat output to maintain a sufficiently high concentration of the alcohol at this point in the column.

The concentration of the carbonic acid compound in the feed is between 0.01 and 2 wt %.

The distillation column has at least one dephlegmator arranged downstream of it in which the carbonic acid salts of the ammonia that are being generated are intentionally crystallized out on the heat exchanger surfaces and removed from the ammonia. It is preferable to run two dephlegmators in parallel in order that they may be cleaned alternately without interrupting operation of the method. The loading of the at least one dephlegmator can be monitored, for example, via differential pressure and/or measurement of the offgas temperature and/or CO₂ measurement in the gas stream. The dephlegmators may also have a total condenser arranged downstream of them which liquefies the gaseous ammonia depleted of CO₂ and alcohol.

Cleaning of the laden dephlegmators may be effected elegantly in the liquid or gas phase. Liquid-phase cleaning is accomplished with water or the employed alcohol itself and also with steam which accordingly condenses on the heat exchanger surfaces. Gas-phase cleaning may be effected with air, inert gas or the removed ammonia itself. Here, the gas temperature needs to be higher than the decomposition temperature of the ammonium salt at the operating pressure in question. Cleaning with hot ammonia belonging to the system is preferred. The laden ammonia stream may be supplied directly to a process for preparing hydrocyanic acid to avoid additional disposal costs. Both the liquid- and gas-phase cleaning may be effected at operating pressure.

The solution has an ammonia content of 2-30, preferably 5-20 and more preferably 8-11 wt % based on the total feed stream. The ammonia obtained downstream of the final condenser has an alcohol content of <5, preferably <2 and more preferably <1.5 wt % alcohol. The alcohol discharged from the column bottom comprises ammonia in an amount of <1, preferably <0.5 and more preferably <0.3 wt %.

Preference is given to one version wherein a solution obtained from a methanolysis of hydroxyisobutyramide (HIBA) to give methyl hydroxyisobutyrate (MHIB) as described in EP 2018362 or WO2013026603 for example is worked up using the method according to the invention. This solution is to be worked up such that the MeOH may be recycled into the reaction ideally free of ammonia since the equilibrium in the methanolysis reaction to give MHIB is unfavourably influenced by ammonia. By the same token the ammonia to be fed into an Andrussow process for example should ideally be free of methanol. In this version, the solution comprises different amounts of trimethylamine, dimethyl ether and formamide impurities as well as ammonia, MeOH and CO₂.

In this version, the maximum concentrations of the individual components in the solution, in each case given in wt % based on the total feed stream, are: ammonia <15, trimethylamine <1.0, dimethyl ether <0.2, CO₂ <1.0, formamide <2.0, water <1.0, the remainder being MeOH.

The examples which follow are intended to illustrate the invention but not limit it in any way.

### COMPARATIVE EXAMPLE 1

### Adsorption With Basic Ion Exchanger

A feed solution comprising 7% ammonia, 0.4% trimethylamine, 91.5% MeOH, 0.1% dimethyl ether, 0.2% CO₂, 0.2% H₂O and 0.6% formamide (all wt %) was passed over a fixed bed packed with 340 ml (370 meq) of the weakly basic ion exchanger Lewatit® Monoplus 500 MP at 60° C. at a rate of 2 ml/min. Here, CO₂ is to be understood as meaning the sum of dissolved CO₂ and ionic hydrogencarbonate and carbonate. The fixed bed was a stainless-steel jacketed tube of 3 cm internal diameter which was heated to 60° C. with heat-transfer oil (Marlotherm SH) for this experiment. The ion exchanger was conditioned in accordance with the manufacturer's instructions before starting the experiment.

The CO₂ content in the output stream was determined using an ion-selective CO₂ sensor (potentiometric CO₂ sensor, Mettler Toledo type 51 341 200). The experiment was terminated once the CO₂ value had reached 50% of the feed stream value.

Initially, complete depletion of the CO₂ in the feed solution was accomplished. The CO₂ absorption at the end of the experiment was 13.9 g. The liquid reactor contents were discharged and the bed was washed with one bed volume (BV) of water and regenerated with 2 BV of 5% NaOH at room temperature in accordance with the manufacturer's instructions.

It was subsequently necessary to wash the bed with 5 BV of water until NaOH and Na₂CO₃ were no longer detectable in the output stream. The bed was then washed with 3 BV of MeOH in order to achieve a water content in the washing MeOH of less than 2 wt % and thus condition the bed for the next run. Regeneration and conditioning thus generate a total of 10 BV of output streams requiring disposal or reuse elsewhere.

### COMPARATIVE EXAMPLE 2

### Adsorption Using CaO at 60° C. Without Addition of Water

A feed solution comprising 7% NH₃, 0.4% trimethylamine, 92.0% MeOH, 0.2% CO₂ and 0.2% H₂O (all wt %) was passed over a fixed bed which with 25 g CaO (available e.g. from Dräger under the name Atemkalk, dp=3.5 mm) under a slight overpressure (3 bara) at 60° C. at a rate of 1 ml/min. This fixed bed, a jacketed reactor of pressure-resistant glass, had an internal diameter of 1.6 cm. The fixed bed was heated with hot oil (Marlotherm SH). The mass, reckoned as CO₂, absorbed by the adsorbent before penetration of CO₂ was detected was 0.4 g. The CaO pellets were visually unchanged at the end of the experiment.

### COMPARATIVE EXAMPLE 3

### Adsorption Using CaO at 60° C. With Water Addition

The experiment of Comparative Example 2 was repeated, a feed water content of 5 wt % being established by addition of water. The mass, reckoned as CO₂, absorbed by the adsorbent before penetration of CO₂ was detected was 0.45 g. The CaO pellets were visually unchanged at the end of the experiment.

### COMPARATIVE EXAMPLE 4

### Adsorption Using CaO at 120° C. With Addition of Water

The experiment of Comparative Example 3 was repeated, the adsorber bed being heated to 120° C. this time. The mass, reckoned as CO₂, absorbed by the adsorbent before penetration of CO₂ was detected was 10.4 g. The CaO pellets were visually unchanged at the end of the experiment.

### COMPARATIVE EXAMPLE 5

### Adsorption CaO at 120° C. With Addition of Water in the Presence of Formamide

The water content of the feed from Comparative Example 1 was adjusted to 5 wt % by addition of water. The experiment of Comparative Example 4 was repeated with this feed. The mass, reckoned as CO₂, absorbed by the adsorbent before penetration of CO₂ was detected was only 2.5 g. Reduction of formamide was detected (GC) in the output stream of the fixed bed concurrently with CO₂ depletion. It was moreover possible to detect up to 300 ppm of calcium ions (atomic adsorption spectrometry) and up to 650 ppm of formate ions (ion chromatography analysis) in the output stream samples. Due to the presence of formamide, said formamide is evidently bound by the CaO in preference to CO₂ and tends to dissolve in the water-enriched methanolic solution which leads to unwanted leaching of calcium ions into the process as well as reduced CO₂ absorption.

### COMPARATIVE EXAMPLE 6

### Operation of the Column With Stripping Section and Rectifying Section

A stainless-steel column was employed whose stripping section has been fitted with 40 bubble-cap trays (diameter 150 mm), the rectifying section comprising 10 bubble-cap trays of 65 mm in diameter. The column bottom is electrically heated. The column may be operated at a pressure of up to 30 bar. The bottoms output stream and the distillate were analysed by GC.

The column was supplied with a feed of 23 kg/h (fed to tray 40 from below) having the same composition as that in Comparative Example 1, The operating pressure of the column was 20 bar and it was therefore possible to liquefy the ammonia drawn off at the top of the column in a condenser operated with cooling water. A reflux of 4 kg/h was established to prevent MeOH passing over. In this experiment, a bottoms stream of 21.2 kg/h was drawn off which still comprised 800 ppm of NH₃. The condensate stream of 1.7 kg/h consisted of 91.3% NH₃, 5.3% TMA, 2% MeOH and 1.3% DME (all wt %).

The column needed to be shut down due to flooding after just a few hours. Opening the column revealed ammonium carbamate deposits on the upper trays of the rectifying section, in the vapours pipe and on the tubes of the condenser.

### COMPARATIVE EXAMPLE 7

### Operation of the Column With Stripping Section and Rectifying Section in the Presence of KOH

The experiment of Comparative Example 6 was substantially repeated but this time 2.5 kg/h of a 10% KOH solution were additionally introduced to tray 6 of the rectifying section. A reflux of 10 kg/h was necessary to obtain pure NH₃ as overhead product. It was possible to operate the column continuously over a period of 30 d. The condensate stream of 1.8 kg/h this time consisted of 90.5% NH₃, 5.2% TMA, 2.0% H₂O, 1.0% MeOH and 1.3% DME (all wt %). The drawn off bottoms output stream consisting of MeOH, water, potassium hydrogencarbonate, potassium formate, residual KOH and 200 ppm of NH₃ formed one homogeneous phase. Recovery of the MeOH required a further distillative purification step wherein the MeOH was drawn off as overhead product in a still to leave behind an aqueous solution of the salts.

### COMPARATIVE EXAMPLE 8

### Operation of the Column With Stripping Section and Rectifying Section in the Presence of a Small Amount of KOH

Comparative Example 7 was substantially repeated, the amount of KOH employed being reduced such that the amount of KOH added corresponded to only 90 mol % of the amount of CO₂ and formamide in the column feed. Here too, operation of the column needed to be interrupted due to flooding after only a few hours. Solid deposits were again detected at the points in the column described in Comparative Example 6.

### COMPARATIVE EXAMPLE 9

### Operation of the Column With Stripping Section and Rectifying Section in the Presence of K₂CO₃

Comparative Example 7 was substantially repeated, the concentration of formamide in the feed having been somewhat reduced (7% NH₃, 0.4% trimethylamine, 91.8% MeOH, 0.2% CO₂, 0.2% H₂O and 0.2% formamide—all wt %). This time, instead of KOH, a 10% K₂CO₃ solution was added at 4.8 kg/h at the same point in the column. It was possible to operate the column continuously over a period of 7 d without flooding or any signs of solid precipitation. The condensate stream of 1.8 kg/h this time consisted of 91.0% NH₃, 5.2% TMA, 1.8% H₂O, 0.7% MeOH and 1.3% DME (all wt %).

The drawn off bottoms output stream consisting of MeO, water, potassium hydrogencarbonate, potassium formate, residual K₂CO₃ and 400 ppm of NH₃ formed one homogeneous phase.

The MeOH was recovered by feeding at 26 kg/h the bottoms stream to the middle of a still (rectifying section diameter 130 mm, 1.6 m of structured packing Rombopak 9M from Kühni; stripping section diameter 130 mm, 3.1 m of Rombopak 9M), wherein the MeOH was drawn off as overhead product. A reflux of 10 kg/h was established to obtain MeOH in high purity. The column was operated at 800 mbar.

A CO₂ content of 0.2 wt % was measured in the MeO drawn off. CO₂ depletion with K₂CO₃ is thus unsuitable for removing CO₂ from solvents having a boiling point below that of water since during recovery of the solvent the bound CO₂ is automatically liberated again by the back decomposition of the KHCO₃ and is thus not removed from the process or else would require a further separation step to separate CO₂ and the solvent for its removal from the process.

Operating the column at yet further reduced pressure in order to reduce the bottoms temperature to such an extent that the back cleavage of KHCO₃ is reduced is uneconomical since complete condensation of the MeOH becomes more and more costly and inconvenient the further the pressure is reduced.

The bottoms from the MeOH recovery column further comprise the feed-commensurate molar amount of potassium formate as well as the reformed K₂CO₃.

Potassium formate does not undergo decomposition under these conditions. In order to avoid accumulation of this component when recycling the CO₂ adsorbent, it is necessary to continuously run a defined effluent stream which entails additional waste.

### COMPARATIVE EXAMPLE 10

### Feed Introduction at Uppermost Tray

A bubble-cap tray column, this time of glass, was employed which comprises 20 bubble-cap trays of 50 mm in diameter. The spacing between 2 trays in this column is 5.5 cm. The feed from Comparative Example 1 is introduced to the uppermost tray of the column (tray 20) at 250 g/h. The column bottom is electrically heated. The column is operated at atmospheric pressure. Two parallel switchable glass condensers operated with cooling water (15° C.) have been installed at the top of the column, a brine cooler being connected downstream thereof (minus 5° C.). The heat exchangers operate in dephlegmatic fashion under the prevailing conditions and NH₃ is therefore drawn off in gaseous form. The liquid condensate streams from the operating condenser and the brine cooler are combined and introduced to the column as reflux. The gaseous ammonia-containing offgas is drawn off. The heat exchangers may be cleaned with H₂O when fouled with carbamate.

The column bottom heat output is adjusted such that the temperature at the uppermost tray 20 is 35° C. The ammonia concentration at this point in the column was determined as 11.5 wt %. An MeOH stream of 0.23 kg/h still comprising 150 ppm of NH₃ (GC) was drawn off at the column bottom.

Onset of solid formation (ammonium carbamate) was observed at tray 17 after 22 hours. The experiment was consequently terminated.

### EXAMPLE 1

### Feed Introduction at Uppermost Tray

The experimental procedure corresponds to that of Comparative Example 10. The column bottom heat output was adjusted such that the temperature at tray 20 was 40° C. The ammonia concentration at tray 20 was 9.7 wt %.

It was possible to achieve disruption-free operation of the column without solid formation over 160 h. Solid formation (intentional carbamate deposition) occurred only at the condensers. It was possible to clean the heat exchanger surfaces with water without any problems.

### EXAMPLE 2

### Feed Introduction at Middle of Column

The experimental procedure corresponds to that of Example 1. The ammonia concentration at tray 20 was 9.4 wt %. The column bottom heat output was adjusted such that the temperature at tray 20 was 40° C. The feed was introduced to column tray 10 (i.e. middle of column).

Here too, it was possible to achieve disruption-free operation of the column without solid formation over 160 h. Solid formation (intentional carbamate deposition) occurred only at the condensers. It was possible to clean the heat exchanger surfaces with water without any problems.

### COMPARATIVE EXAMPLE 11

### Feed Introduction at Middle of Column

The experimental procedure corresponds to that of Example 2. The ammonia concentration at tray 20 was 11.2 wt %. The feed was introduced to column tray 10 (i.e. middle of column). The column bottom heat output was adjusted such that the temperature at tray 20 was 35° C.

Onset of solid formation (ammonium carbamate) was observed at trays 18-19 after 30 h. Within 48 h the amount of solid increases to such an extent that the column floods. The experiment was terminated.

### EXAMPLE 3

### Operation of the Column With Stripping section at 1 Bar

The steel column from Comparative Example 6 was employed without a rectifying section. Two parallel switchable tube bundle condensers operated in dephlegmatic fashion with cooling water (15° C.) were installed at the top of the column, a brine cooler (−5° C.) being arranged downstream thereof. Differential pressure measuring means which indicate fouling have been installed to monitor the two heat exchangers. Cleaning may be effected with 3 bar of steam which condenses during cleaning.

The column is supplied with a feed of 23 kg/h having the same composition as that in Comparative Example 1. As before, the feed is introduced to tray 40 which is now the uppermost tray. The column operating pressure was reduced to 1 bar and ammonia could therefore be drawn off downstream of the dephlegmators in gaseous form. The column is operated such that the temperature of the feed tray does not fall below 40° C. An NH3 concentration of 9.7 wt % was measured at the uppermost tray.

In this experiment, a bottoms stream of 21.2 kWh was drawn off which still comprised 200 ppm of NH₃. The offgas consisted of 92.1 wt % NH₃, 5.4 wt % trimethylamine and 2.5 wt % MeOH. Periodic cleaning of the condensers at 20 h intervals makes it possible to achieve disruption-free operation of the column over a period of 3 weeks.

### EXAMPLE 4

### Operation of the Column With a Stripping Section at 3 Bar

The experiment of Example 3 was repeated, the column pressure being adjusted to 3 bara. The column is operated such that the temperature of the feed tray does not fall below 71° C. An NH₃ concentration of 9.8 wt % was measured at the uppermost tray.

After cleaning, the heat exchangers are dried with nitrogen, a pressure of 3 bara is re-established and said condensers can therefore be readily brought online without pressure fluctuations.

A bottoms stream of 21.2 kg/h was drawn off which still comprised 400 ppm of NH₃, The offgas consisted of 94.3 wt % NH₃, 5.4 wt % TMA and 0.3 wt % MeOH. Periodic cleaning of the condensers at 20 h intervals makes it possible to achieve disruption-free operation of the column over a period of 3 weeks.

Experiments were carried out concerning alternative methods of cleaning the carbamate-fouled condensers.

### EXAMPLE 5

### Ammonium Carbamate Removal by Cleaning with Air

8 g of ammonium carbamate are initially charged into a glass tube which has 200 g/h of air preheated to 100° C. passed over it at 1 bara. All of the carbamate had been removed after 60 min.

### EXAMPLE 6

### Ammonium Carbamate Removal by Cleaning with NH₃

8 g of ammonium carbamate are initially charged into a glass tube which has 200 g/h of NH₃ preheated to 100° C. passed over it at 1 bara. All of the carbamate had been removed after 60 min.

It is preferable to use NH₃ which is generated as offgas from the condensers and which normally requires preheating to be used in HCN synthesis. This NH₃ stream is moreover automatically at the pressure at which the crystal condensers are operated.

### Gas Chromatography Conditions of Measurement:

CP-3800 gas chromatograph; injector: 1079 PTV; column: DB-WAXERT (Agilent), length 30 m, ID 0.53 mm, film thickness 1.5 μm+precolumn; thermal conductivity detector; carrier gas: helium; the column is heated from 40-240° C. at a heating rate of 20 K/min using a temperature programme.

1. A method of removing ammonia from an alcoholic solution comprising at least one alcohol, one carbonic acid compound and ammonia, the method comprising:
a) introducing the alcoholic solution to a middle, top half or top of a distillation column; and
b) adjusting, pressure and temperature at the introduction point such that ammonium salts of the carbonic acid compound are soluble in the alcohol under operating conditions.

2. The method according to claim 1, wherein ammonia concentration at an uppermost tray of the distillation column does not exceed 10 wt %.

3. The method according to claim 1, wherein column reflux is generated in dephlegmatic fashion and ammonia is removed predominantly in gaseous form.

4. The method according to claim 1, wherein ammonium salt of the carbonic acid compound is deposited outside the distillation column in solid form on at least one condenser and thereby separated from the ammonia.

5. The method according to claim 1, wherein the distillation column is operated at 0.05-5 bar.

6. The method according to claim 1, wherein the alcoholic solution is introduced at the top of the distillation column.

7. The method according to claim 1, wherein a concentration of the carbonic acid compound in the alcoholic solution is between 0.01 and 2 wt %.

8. The method according to claim 1, wherein the alcoholic solution further comprises water.

9. The method according to claim 1, wherein a concentration of ammonia in the alcoholic solution is 2-30 wt %.

10. The method according to claim 1, wherein the alcoholic solution further comprises a di- or trialkylamine, a dialkyl ether, a dialkyl formamide, an alkyl formate, an alkyl acetate, or mixtures thereof.

11. The method according to claim 1, wherein ammonia obtained overhead comprises less than 5 wt % of alcohol.

12. The method according to claim 1, wherein alcohol discharged from the distillation column bottom comprises less than 1 wt % of ammonia.

13. The method according to claim 1, wherein ammonia obtained overhead is fed into a process for preparing hydrocyanic acid.

14. The method according to claim 1, wherein the alcohol is methanol.

15. A method according to claim 12, wherein methanol discharged from the distillation column bottom is recycled into a hydroxyisobutyramide methanolysis.

16. A method of removing ammonia from an alcoholic solution comprising at least one alcohol, one carbonic acid compound and ammonia, the method comprising:
a) introducing the alcoholic solution to a middle, top half or top of a distillation column; and
b) adjusting pressure and temperature at the introduction point such that ammonium salts of the carbonic acid compound are soluble in the alcohol under operating conditions,
wherein ammonia concentration at an uppermost tray of the distillation column does not exceed 10 wt %.

17. The method according to claim 2, wherein a temperature at he uppermost tray of the distillation column does not fall below 40° C.

18. The method according to claim 16, wherein a temperature at the uppermost tray of the distillation column does not fall below 40° C.

19. The method according to claim 1, wherein the method does not include stripping the alcoholic solution with an inert gas.

20. A method of removing ammonia from an alcoholic solution comprising at least one alcohol, one carbonic acid compound and ammonia, the method comprising:
a) introducing the alcoholic solution to a middle, top half or top of a distillation column; and
b) adjusting pressure and temperature at the introduction point such that ammonium salts of the carbonic acid compound are soluble in the alcohol under operating conditions,
wherein an ammonium salt of the carbonic acid is deposited outside of the distillation column as a solid.
